(19) United States
(12) Patent Application Publication
(10) Pub. No.: US 2014/0188567 A1
(43) Pub. Date: Jul. 3, 2014

(54) PRODUCT DETERMINATION FOR A PORTFOLIO

(71) Applicant: HEWLET-PACKARD DEVELOPMENT COMPANY, L.P., Houston, TX (US)

(72) Inventors: Ruxian WANG, Mountain View, CA (US); Jose Luis BELTRAN GUERRERO, Mountain View, CA (US); Guillermo GALLEGO, Waldwick, NJ (US); Jianqiang WANG, Mountain View, CA (US); Kay-Yut CHEN, Santa Clara, CA (US); Shailendra K. JAIN, Cupertino, CA (US)

(73) Assignee: HEWLETT-PACKARD DEVELOPMENT COMPANY, L.P., Houston, TX (US)

(21) Appl. No.: 13/733,274

(22) Filed: Jan. 3, 2013

(51) Int. Cl. G06Q 30/02

(52) U.S. Cl. 705/7.35

(57) ABSTRACT

A system includes an intersection engine to determine intersection points between multiple first functions, each first function corresponding to a product from a plurality of products and each first function based on the corresponding product's utility and profit at a given price point. The system further includes a first ranking engine to rank the intersection points and a second ranking engine to rank the first functions based on the intersection points. The system further includes a solving engine to solve a second function based on a subset of the ranked functions to determine a subset of the products to include in a product portfolio and a price for each product in the portfolio to maximize profit for the plurality of products.

### BACKGROUND

Because of competition and erosion of profit margins, manufacturers and vendors are under pressure to increase profits and market share. A manufacturer/vendor may provide any number of products within the capabilities of the manufacturer/provider. Product variety, however, increases operating cost as well as the complexity of management in manufacturing, logistics and marketing. Product variety may also slow down customer purchase decisions or decrease their purchase likelihood because there may be too many alternatives to compare. Too many alternatives may have a negative effect on demand. Further, some products may have a very low profit margin.

### BRIEF DESCRIPTION OF THE DRAWINGS

For a detailed description of various examples, reference will now be made to the accompanying drawings in which:

FIG. 1 shows a system diagram in accordance with various examples;

FIG. 2 shows an example of a product portfolio determination system in accordance with various examples;

FIG. 3 shows an illustrative implementation of a product portfolio determination system in accordance with various examples;

FIG. 4 illustrates the relationship and intersection points of various first function in accordance with examples of the disclosure; and

FIG. 5 shows a method in accordance with various examples.

### DETAILED DESCRIPTION

The present disclosure is generally directed the determination of a set of products to offer in a portfolio of products in order to maximize an attribute of the products. The term “product” refers to a good or service. The term “portfolio” broadly refers to a collection of products. The “attribute” to be maximized may refer to profit, sales revenue, or any other measured value of the offered products in the portfolio. While the illustrative implementation provided herein refers to maximizing a portfolio's profit, other implementations may maximize a different attribute of the portfolio. References to “profit” may refer to profit margin.

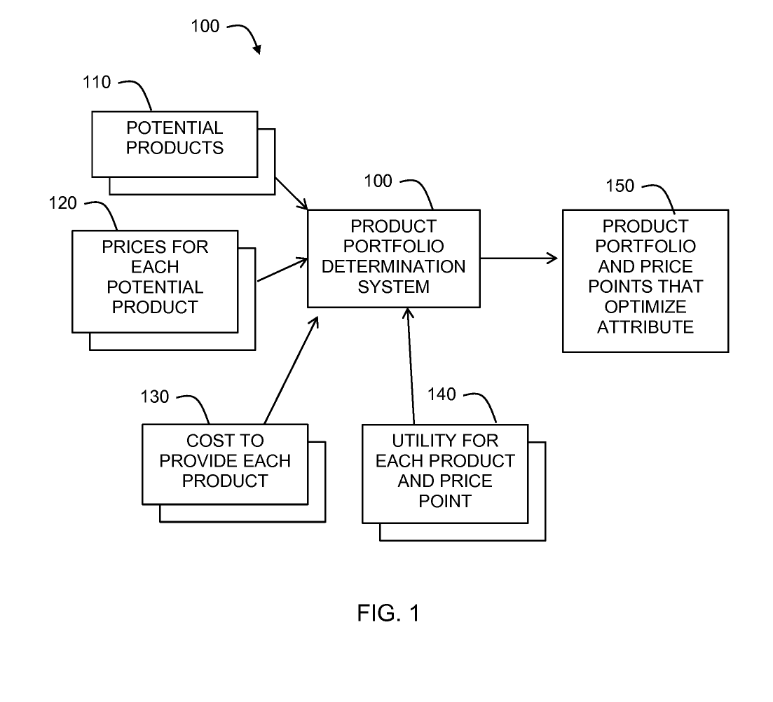

FIG. 1 illustrates a product portfolio determination system 100 that receives various inputs and generates an output. The inputs include various potential products 110, one or more prices 120 for each of the potential products, the historical cost 130 to provide each of the potential products 110, and the utility 140 of each of the potential products and corresponding price points.

The potential products 110 include the various products that potentially can be offered in a portfolio of products. Products determined to be included in the portfolio may be offered for sale or use by users without being sold. Of the various potential products 110, the product portfolio determination system 100 determines which subset of the potential products should be included in a product portfolio in order to maximize an attribute (profit in this example). One or more or all of the potential products 110 may be determined to be included in the product portfolio by the product portfolio determination system 100. The potential products 110 may be stored in a data structure such as a file that is accessible to the product portfolio determination system 100.

The prices 120 include one or more discrete prices for each potential product 110. For example, one of the potential products 110 may include a laptop computer that may be provided at discrete prices of $500, $600, and $750. In this example, prices 120 include three different prices for the laptop computer. The price(s) 120 for one potential product 110 may include any number of prices and may be the same or different than the prices of other products.

The cost 130 to provide each potential product may include the costs to manufacture, distribute, market and otherwise provide the product to the end user. Cost 130 is known based on calculations, estimates, and/or from prior experience providing each such product.

The utility 140 for a given potential product represents the profit contribution of this product at a particular price point and is a function, at least in part, of the price 120 for the product. Thus, a product's utility 140 takes into account the product at a particular price point. The utility 140 for a given potential product 110 at a given price 120 may be different than the utility for the same product at a different price point. In some implementations, utility may be represented as a mathematical model that may be linear or non-linear with respect to price.

The product portfolio determination system 100 processes the various inputs 110-140 and determines the product portfolio and price points 150 that optimize profit (or other attribute of interest). The output product portfolio and price points 150 may be provided as a list of product names or other types of descriptions along with the price point at which each such product should be provided in order to result in a maximum total profit for the portfolio. That is, the particular portfolio of products determined by the product portfolio determination system 100 is likely to result in a higher profit level than any other combination of potential products selected for the portfolio.

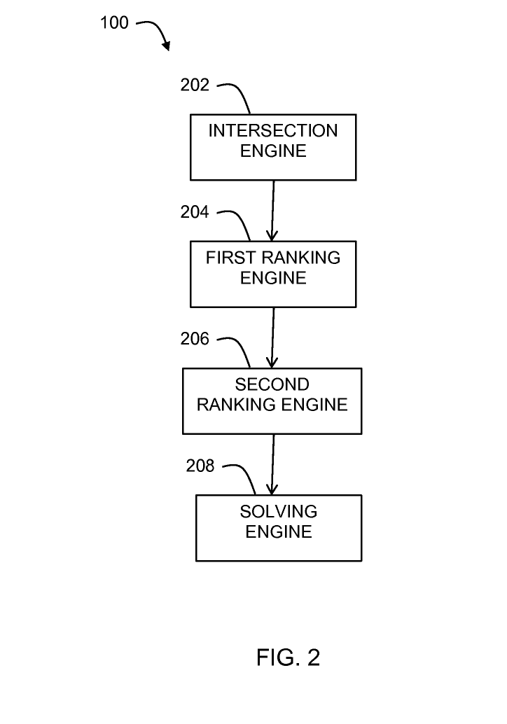

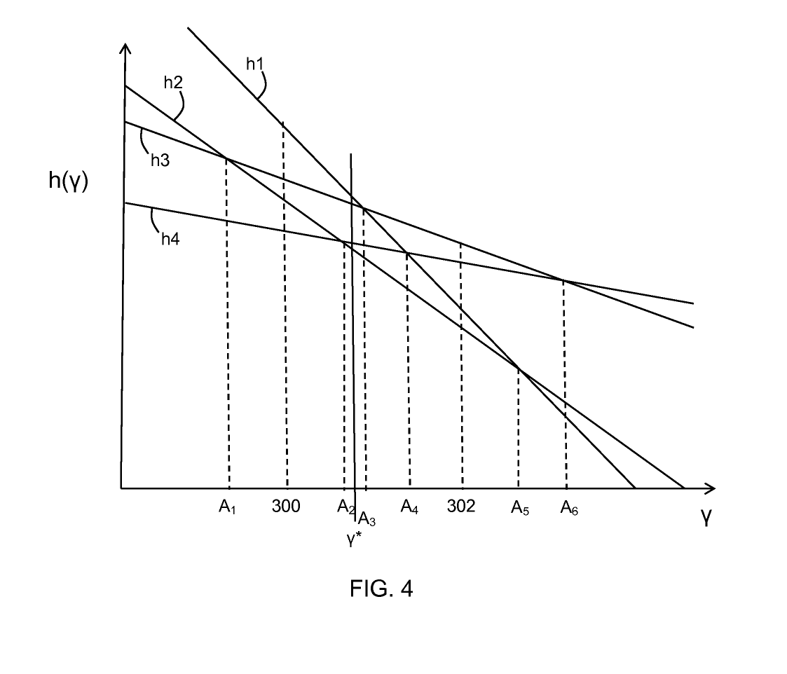

FIG. 2 illustrates an example of the product portfolio determination system 100. The illustrative system 100 includes various engines that provide the system with the functionality described herein. The system 100 may include an intersection engine 202, a first ranking engine 204, a second ranking engine 206, and a solving engine 208. Although the various engines 202-208 are shown as separate engines in FIG. 2, in other implementations, the functionality of two or more or all of the engines 202-208 may be implemented as a single engine. The functionality implemented on these engines will be further explained below with regard to FIG. 4.

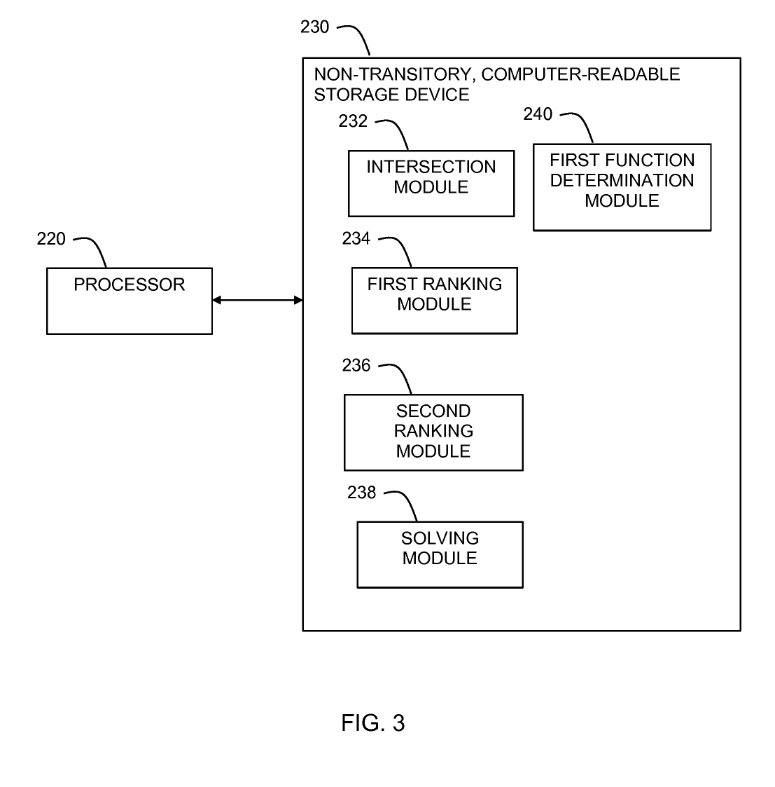

In some examples of the system 100, each engine 202-208 may be implemented as a processor executing software. FIG. 3, for example, shows one suitable example in which a processor 220 is coupled to a non-transitory, computer-readable storage device 230. The non-transitory, computer-readable storage device 230 may be implemented as volatile storage (e.g., random access memory), non-volatile storage (e.g., hard disk drive, optical storage, solid-state storage, etc.) or combinations of various types of volatile and/or non-volatile storage.

The non-transitory, computer-readable storage device 230 is shown in FIG. 3 to include a software module that corresponds functionally to each of the engines of FIG. 2. The software modules may include an intersection module 232, a first ranking module 234, a second ranking module 236, and a solving module 238. Additional modules may be provided including, for example, a first function determination module 240, and the system of FIG. 2 also may include a corresponding first function determination engine. Each engine of FIG. 2 may be implemented as the processor 220 executing the corresponding software module of FIG. 3.

The distinction among the various engines 202-208 and among the software modules 232-240 is made herein for ease of explanation. In some implementations, however, the functionality of two or more of the engines/modules may be combined together into a single engine/module. Further, the functionality described herein as being attributed to each engine 202-208 is applicable to the software module corresponding to each such engine, and the functionality described herein as being performed by a given module is applicable as well as to the corresponding engine.

The principles disclosed herein are based, in part, on the use of one or more attraction models. Attraction models estimate demand where consumers may substitute and buy from different providers or different products from the same provider. Any of a variety of attraction models, such as the MultiNomial Logit (MNL) model, may be used to capture demand interdependencies. Such models fit actual data well in scenarios where customers choose among a set of alternative products. Although the following discussion includes the use of the MNL model, any of various other attraction models may be used instead.

The MNL model can be derived from the underlying random utility maximization model. Suppose that N:={1, 2, . . . n} is the product set in consideration. The utility Uᵢ of product i at price pᵢ can be decomposed into two parts: a deterministic component uᵢ(pᵢ) and a random component εᵢ, that is:

Uᵢ=uᵢ(pᵢ)+εᵢ

Without loss of generality, the utility of the non-purchase option is assumed to be U₀=ε₀, where ε₀ is also a random variable. According to the random utility maximization model, the probability that an individual selects alternative i given price vector p:=(pᵢ)_{i∈N} is:

dᵢ(S;pₛ)=Pr(Uᵢ≧max{Uₛ:s∈S⁺}),∀ᵢ∈S⁺; (1)

where S⁺=S∪{0}.

It is also assumed that {εᵢ; i=0, 1, . . . , n} are independent identical distributed (i.i.d.) random variables with a Gumbel or type I generalized extreme value (GEV) distribution:

Pr(εᵢ≦x)=e^{-e-(x+γ),}

where γ is Euler's constant (γ≈0.5772). Then, equation (1) results in the MNL model:

$${d}_{i} ( S , {p}_{s} ) = \frac{{e}^{{u}_{i} ( {p}_{i} )}}{1 + {\sum }_{s ∈ S} {e}^{{u}_{S} ( {p}_{S} )}} ∀ i ∈ S \qquad ( 2 )$$

A suitable utility function is the linear model: uᵢ(pᵢ)=αᵢ−βᵢpᵢ, where αᵢ takes into account all feature values excluding price, and βᵢ(βᵢ>0) is the price-sensitivity parameter indicating how sensitive customers are to the price change of product i. Then, the MNL model (2) becomes

$${d}_{i} i ( S , {p}_{s} ) = \frac{{e}^{{α}_{i} - {β}_{i} {p}_{i}}}{1 + {\sum }_{s = S} {e}^{{α}_{s}} - {β}_{s} {p}_{s}} ∀ i ∈ S \qquad ( 3 )$$

As explained above, the system described herein determines the assortment of products to include in the portfolio and determines their prices to maximize the total expected profit. The unit cost is given by cᵢ for product i∈N. The capacitated assortment and price optimization under the MNL model can be formulated as follows

maxR(S,pₛ)=MΣ_{i∈s}(pᵢ−cᵢ)dᵢ(S,pₛ), (4)

s:t.,x≦|S|≦ x̅

pᵢ≦pᵢ≦ p̅ᵢ

where M is the market size, x and x̅ are the lower bound and upper bound of the number of selected products, and pᵢ and p̅ᵢ are the bounds for price pᵢ. Because the choice is very nonlinear, it is hard to optimize the profit function, especially when there are many candidate products.

The cardinality constraint and price bounds in problem (4) may result from business applications. For example, the shelf space to display products may be limited; a web page may be able to list only a limited number of items. Moreover, an increase number of products unfortunately may result in a higher operating cost and increased difficulties in demand forecasting for each product. And inventories should be maintained at a higher level to maintain target service rates. Financial budget is another reason to limit the number of offered products. The model parameters may be obtained from regression study based on available data.

The disclosed techniques may involve discretizing prices. Let (p_{i;1}, p_{i;2}, . . . , p_{i;mi}) be the possible prices of product i, where p_{i,1} may be the lower bound pᵢ and p_{i;mi} may be the upper bound p̅ᵢ. Let binary variables to denote the price decision (x_{i,1}, x_{i,2}, . . . , x_{i,mi}), where x_{i;r}=1 if and only if price p_{i,r} is selected; x_{i,r}=0 otherwise. If all x_{i,r} are zero for some product i, i.e., Σᵣ₌₁^{m}^{ᵢ}x_{i,r}=0, then product l is not included in the portfolio. Then, the probability that a customer selects product i at price s_{i,r} is:

$${d}_{i , r} ( x ) = \frac{{u}_{i} ( {p}_{i , r} ) {x}_{i , r}}{{a}_{0} + {\sum }_{j = 1}^{n} {\sum }_{r = 1}^{{m}_{j}} {u}_{j} ( {p}_{j , r} ) {x}_{j , r}} \qquad ( 5 )$$

So, the problem can be formulated as follows:

maxₓΣᵢ₌₁ⁿΣᵣ₌₁^{m}^{ⱼ}(p_{i,r}−cᵢ)d_{i,r}(x) (6)

s.t.,Σᵣ₌₁^{m}^{ᵢ}x_{i,r}≦1,i=1,2, . . . . nᵢ (7)

x≦Σᵢ₌₁ⁿΣᵣ₌₁^{m}^{ⱼ}x_{i,r}≦ x̅ (8)

x_{i,r}=0,1,∀i,r (9)

Equation (7) defines a constraint that the product cannot be sold at multiple prices. Equation (8) is the constraint on the number of products to be sold in the market, and equation (9) specifies that a product can be sold at only one price.

Let S be the offered product set, i.e., S⊂{1, 2, . . . , n}. Let Pᵢ={1, 2, . . . , mᵢ} be the index set of possible price points for product i, i.e., p_{i,r} is a possible price point for each r∈Pᵢ. The problem specified by equations (6)-(9) above can be transferred to an assortment optimization problem, where prices or margins for all the products in consideration are fixed. mᵢ copies for product i are created corresponding to different price levels. Let Qᵢ be the offered product set among the mᵢ copies, i.e., Qᵢ⊂Pᵢ and introduce a constraint |Qᵢ|≦1, which represents that a product cannot be sold at multiple prices and |Qᵢ| represents the cardinality of set Qᵢ. A modified formulation for problem of equations (6)-(9) can be formally expressed as follows:

$${max}_{S , {Q}_{i}} {\sum }_{i ∈ S} {\sum }_{r ∈ {Q}_{i}} \frac{{v}_{i , r}}{{a}_{0} + {\sum }_{i ∈ S} {\sum }_{r ∈ {Q}_{i}} {k}_{i , r}} \\ s \text{:} t . , \underline{x} \leq \vert S \vert \leq \overline{x} \\ ⌊ {Q}_{i} ⌋ \leq 1 , ∀ i , r \qquad ( 10 )$$

Based on some algebra, the above problem (10) can be rewritten in the following way:

$$max γ \\ s \text{:} t . , γ \leq {\sum }_{i ∈ S} {\sum }_{r ∈ {Q}_{i}} {\hat{v}}_{i , r} - {\hat{k}}_{i , r} γ \\ \underline{x} \leq \vert S \vert \leq \overline{x} \\ ⌊ {Q}_{i} ⌋ \leq 1 , ∀ i ∈ S \qquad ( 11 )$$

where \hat{ν}_{i,r}=v_{i,r}/a₀ and \hat{k}_{i,r}=k_{i,r}/a₀ for any i∈S and r∈Qᵢ.

A new function then can be Introduced as follows:

$$Z ( γ ) = {max}_{S , {Q}_{i}} {\sum }_{i ∈ S} {\sum }_{r ∈ {Q}_{i}} {\hat{v}}_{i , r} - {\hat{k}}_{i , r} γ$$

$$s . t . , \underline{x} \leq \vert S \vert \leq \overline{x}$$

$$⌊ {Q}_{i} ⌋ \leq 1 , ∀ i ∈ S$$

Defining a function Z(γ) for each γ generally may be computationally costly. Accordingly, a more efficient method to find a function Z(γ) for each γ is provided below.

Let the linear functions h_{i,r}R→R for all i∈N⁺:={0, 1, 2, . . . n} be defined by:

h₀(γ)=0,

h_{i,r}(γ)=\hat{ν}_{i,r}−\hat{k}_{i,r}γ,∀i∈M,r∈Pᵢ (13)

For each pair of h_{i,r}(γ) and h_{j,s}(γ) with \hat{ν}_{i,r}≧\hat{ν}_{j,s} and \hat{k}_{i,r}>k_{j,s}i≠j let A_{i,r,j,s} denote the x-coordinate of the intersection point between lines h_{i,r}(γ) and h_{j,s}(γ). The x-coordinate of the intersection point between two such h functions can be expressed as follows:

$${A}_{i , r , j , s} = \frac{{\hat{v}}_{i , r} - {\hat{v}}_{j , s}}{{\hat{k}}_{i , r} - {\hat{k}}_{j , s}} \qquad ( 14 )$$

FIG. 4 illustrates examples of four h_{i,r}(γ) functions designed as h1-h4, although in general there may be any number of h_{i,r}(γ) functions. The functions are linear with respect to γ and have varying slopes and x and y intercepts. The various h_{i,r}(γ) functions thus intersect each other as shown. The x-coordinates of the intersection points are shown as A_{1,}A₂, A₃, A₄, A₅ and A₆ in order from smallest to largest x-coordinate value.

The number of intersection points among all the lines {h_{i,r}(γ):i∈N⁺, r∈Pᵢ} is at most M(M+1)/2, where M is the total number of lines in the set {h_{i,r}(γ):i∈N⁺, r∈Pᵢ}. Let τ=((i₁, r₁, j₁, s₁), . . . , (i_{K}, r_{K}, j_{K}, s_{K})) denote the ranking of the intersection points based on the x-coordinates with positive values in increasing order, i.e.:

0=A_{i0,r0,j0,s0}<A_{i1,r1,j1,s1}≦ . . . ≦A_{iK,rK,jK,sK}<A_{iK+1,rK+1,jK+,sK+1}=∞

Two end points A_{i0,r0,j0,s0} and A_{iK+1,rK+1,jK+1,sK+1} have been added to facilitate the process. The added endpoints facilitate the algorithm. In the algorithm, the x-axis is divided into multiple intervals by the intersection points and the algorithm generally focuses on the intervals between consecutive intersection points. The added endpoints permits the algorithm to also consider the interval to the left of the left-most intersection point and to the right of the right-most intersection point. Because there is no intersection between any consecutive pair of endpoints (A_{il,rl,jl,sl} and A_{il+1,rlL+1,sl+1}), the lines {h_{i,r}(γ):i∈N³⁰; r∈Pᵢ} can be ranked from the highest to the lowest values σ^{l}=(σ^{l}₁, . . . , σ^{l}ₘ) and the ranking does not change within each interval, i.e.,

hσ^{l}₁(γ)≦hσ^{l}₂(γ)≦ . . . ≦hσ^{l}ₘ(γ), ∀∈(A_{il,rl,jl,sl},A_{il+1,rl+1,jl+1,sl+1})

Denote set Sₗ as the top x̅ lines with nonnegative values in interval (A_{il,rl,jl,sl}, A_{il+1,rlL+1,jl+1,sl+1}) such that no two lines are in the same set Pᵢ for any i∈N. Then, the function Z(γ) defined in (12) can be rewritten more explicitly as follows:

Z(γ)=Σ_{i∈s}_{ᵢ}h_{i,r}(γ),∀γ∈[A_{il,rl,jl,sl},A_{il+1,rl+1,jl+1,sl+1}] (15)

From the above analysis, a theorem for the optimal solution holds true. Function Z(γ) is decreasing in γ and γ* is computed as the solution to the equation γ=Z(γ). The value γ* represents the total optimal profit. Once the value γ* is computed, S* is computed and represents the set of products to be included in the product portfolio to achieve the optimal profit γ*. Further, Q* is computed which represents the prices to be associated with such product to achieve the optimal profit level.

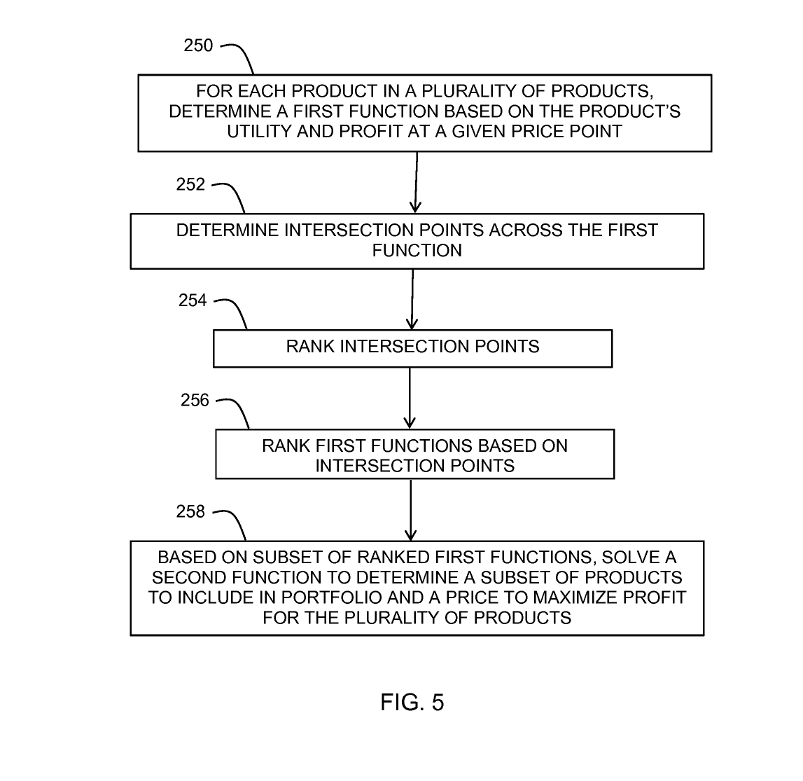

The functions performed by the various engines 202-208 of FIG. 2 and modules 232-240 of FIG. 3 will now be described with reference to the flow diagram of FIG. 5. The h(γ) functions described above are referenced below as “first functions.” The various operations depicted in FIG. 5 may be performed in the order shown or in a different order and two or more of the operations may be performed in parallel instead of serially.

At 250, the method comprises, for each product of the multiple potential products 110, determining a first function (h_{i,r}(γ)) based on the product's utility and profit at a given price point. In some implementations, this operation may be performed by the first function determination module 240 (FIG. 3) setting each product's h_{i,r}(γ) equal to v_{i,r}−k_{i,r}γ. The first functions thus comprise various terms. One term (v_{i,r}) is based on the product's utility and another term (k_{i,r} γ) includes a value based on the product's profit for a given price. The operation to determine the first functions may include processor 220 executing code configured to implement such functions.

At 254, the method includes determining the intersection points between the various first functions. FIG. 4 provides an example of intersection points between pairs of the first functions. The intersection engine 202 of FIG. 2 may be used to determine the intersection points by, for example, computing equation (14) above, which computes the values A_{i,r,j,s}.

At 256, the method includes ranking the intersection points. This operation may be performed by the first ranking engine 204. In some implementations, the first ranking engine 204 ranks the intersection points in order from smallest to largest. The first ranking engine 204 may also add in the two end points noted above (A_{i0,r0,j0,s0} and A_{iK+1,rK+1,jK+1,sK+1}) and then rank all of the intersection points with the end points.

At 258, the method further includes ranking the first functions based on the ranked intersection points (A_{i,r,j,s}) to generate multiple sets of ranked first functions. This operation may be performed by the second ranking engine 206. In some implementations, second ranking engine 206 ranks the first functions by their y-coordinates at a given x-coordinate (γ). For example, FIG. 4 illustrates two sample x-coordinates 300 and 302. X-coordinate 300 is between intersection points A₁ and A₂ and intersection point 302 is between A₄ and A₅ in the example of FIG. 4. The various first functions are ranked by their y-coordinates at the x-coordinate 300 and again ranked by their y-coordinates at x-coordinate 302. At x-coordinate 300, the second ranking engine 206 ranks the first functions as h1>h3>h2>h4. At x-coordinate 302, the second ranking engine 206 ranks the first functions as h3>h4>h1>h2. The rankings are different due to the varying slopes of the various first functions. In various implementations, the second ranking engine 206 may rank the various first functions between every pair of consecutively ranked intersection points. In the example of FIG. 4, the second ranking engine 206 would provide five sets of ranked first functions—one ranked set between each pair of intersection points A1/A2, A2/A3, A3/A4, A4/A5, and A5/A6. The rankings provided above x-coordinates 300 and 302 represent just two of the five sets of ranked first functions—the other three sets of ranked first functions for the example of FIG. 4 are determined in a similar manner.

At 258, the method includes, based on a subset of ranked first functions, solving a second function to determine a subset of products to include in the product portfolio and a price for each such product to maximize profit for the products. This operation may be performed by the solving engine 208. In some implementations, the solving engine 208 may perform this operation as follows. For each set of ranked first functions, the solving engine 208 may select a subset of the ranked first functions. In the example of FIG. 4, the second ranking engine 206 may generate five sets of ranked first functions as explained above. For each of the five sets, the solving engine 208 selects a subset of the ranked first functions. The subset selected may be the largest x functions in each set with nonnegative values. The selected subset of functions is denoted as the set Sₗ above.

The solving engine 208 may compute equation (15) above. That is, the solving engine 208 may, for example, add together the selected subsets of the first functions to generate the function Z(γ). Once the function Z(γ) is generated, the solving engine 208 solves the equation γ=Z(γ) to compute the value γ*. Once γ* is computed, the products for inclusion in the product portfolio can be determined from the first functions. For example, if γ* has a value as shown in FIG. 4 (between intersection points A₂ and A₃ and x is 2 (the top 2 largest first functions were selected in each subset), then the two products associated the first functions h1 and h3 (as indicated by reference numeral 310) are selected for inclusion in the product portfolio.

Once the specific subset of products from the entire set of potential products 110 are determined, the solving engine 208 also determines the price for each such product by identifying the corresponding created h function. Multiple copies may be created for each product at all possible price points. By solving γ=Z(γ), γ* can be found and the corresponding S*, which is a set of h functions. Each h function is created for each product at each possible price point. The optimal price for product i is the corresponding price point for the h function in set S*.

As a result of this process, the specific subset of products from the entire set of potential products are determined as well as corresponding prices that maximize the profit that is likely to be obtainable given an historical assessment of utility for the various products at certain price points.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
for each product of a plurality of products, determining, by executing a module stored on a non-transitory computer-readable storage device, a first function based on the product's utility and profit at a given price point;
determining intersection points across the first functions;
ranking the intersection points;
ranking the first functions based on the intersection points; and
based on a subset of the ranked functions, solving a second function to determine a subset of the products to include in a product portfolio and a price for each product in the portfolio to maximize profit for the plurality of products.

2. The method of claim 1 wherein determining the first function for each product comprises determining a function that includes a plurality of terms, a first term includes a value based on the product's utility and a second term that includes a value based on the product's profit for a given price.

3. The method of claim 1 wherein ranking the first functions comprises ranking the functions between each consecutive pair of intersection points to generate multiple sets of ranked first functions.

4. The method of claim 3 wherein for each set of ranked first functions, selecting a subset of the ranked first functions.

5. The method of claim 4 wherein selecting the subset comprises selecting the top C first functions, where C is user-specified and is the maximum number of offered products.

6. The method of claim 3 further comprising determining the second function based on at least some of the ranked first functions of each set.

7. The method of claim 5 further comprising solving the second function based on the selected top C first functions of each set.

8. The method of claim 3 further comprising using the solution to the second function to select a set of ranked first functions, and determining which products to include in the product portfolio based on the select set of ranked first functions.

9. A non-transitory, computer-readable storage device containing software that, when executed by a processor, causes the processor to:
for each product of a plurality of products, determine a first function based on the product's utility and profit at a given price point;
determine intersection points across the first functions;
rank the intersection points;
rank the first functions based on the intersection points; and
based on a subset of the ranked functions, solve a second function to determine a subset of the products to include in a product portfolio and a price for each product in the portfolio to maximize profit for the plurality of products.

10. The non-transitory, computer-readable storage device of claim 9 wherein the software causes the processor to determine the first function for each product by determining a function that includes a plurality of terms, a first term includes a value based on the product's utility and a second term that includes a value based on the product's profit for a given price.

11. The non-transitory, computer-readable storage device of claim 9 wherein ranking the first functions comprises ranking the functions between each consecutive pair of intersection points to generate multiple sets of ranked first functions.

12. The non-transitory, computer-readable storage device of claim 11 wherein for each set of ranked first functions, selecting a subset of the ranked first functions.

13. The non-transitory, computer-readable storage device of claim 12 wherein selecting the subset comprises selecting the top C first functions, where C is user-specified.

14. The non-transitory, computer-readable storage device of claim 11 further comprising determining the second function based on at least some of the ranked first functions of each set.

15. The non-transitory, computer-readable storage device of claim 13 further comprising solving the second function based on the selected top C first functions of each set.

16. The non-transitory, computer-readable storage device of claim 11 further comprising using the solution to the second function to select a set of ranked first functions, and determining which products to include in the product portfolio based on the select set of ranked first functions.

17. A system, comprising:
an intersection engine to determine intersection points between multiple first functions, each first function corresponding to a product from a plurality of products and each first function based on the corresponding product's utility and profit at a given price point;
a first ranking engine to rank the intersection points;
a second ranking engine to rank the first functions based on the intersection points; and
a solving engine to solve a second function based on a subset of the ranked functions to determine a subset of the products to include in a product portfolio and a price for each product in the portfolio to maximize profit for the plurality of products.

18. The system of claim 9 wherein the second ranking engine ranks the first functions by ranking the functions between each consecutive pair of intersection points to generate multiple sets of ranked first functions.

19. The system of claim 18 wherein, for each set of ranked first functions, the solving engine selecting a subset of the ranked first functions and determines the second function based on the selected subset of the ranked first functions of each set.

20. The system of claim 19 wherein the solving engine determines the subset of products to include in the product portfolio based on a solution to the second function.
